(19) United States
(12) Patent Application Publication
(10) Pub. No.: US 2010/0255353 A1
(43) Pub. Date: Oct. 7, 2010

(54) Thermal switch material suitable for use in controlling short circuits in lithium-ion batteries and method of making the thermal switch material

(76) Inventors: Robert C. McDonald, Stow, MA (US); Katherine E. Harrison, North Cambridge, MA (US); Shelly L. Van Blarcom, West Newton, MA (US); Shannon O'Toole, Westborough, MA (US); Michael P. Moeller, Waltham, MA (US)

Correspondence Address: KRIEGSMAN & KRIEGSMAN, 30 TURNPIKE ROAD, SUITE 9, SOUTHBOROUGH, MA, 01772, US

(21) Appl. No.: 12/653,655

(22) Filed: Dec. 15, 2009

Related U.S. Application Data
(60) Provisional application No. 61/201,791, filed on Dec. 15, 2008.

(51) Int. Cl. H01M 10/50; H01M 2/00; H01B 1/22; B32B 15/08

(52) U.S. Cl. 429/62; 427/126.1; 252/512; 428/422; 977/773; 977/948

(57) ABSTRACT

A composite thermal switch material suitable for use in controlling short circuits in lithium ion batteries. The switch material comprises a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

### CROSS-REFERENCE TO RELATED APPLICATIONS

The present application claims the benefit under 35 U.S.C. 119(e) of U.S. Provisional Patent Application No. 61/201,791, filed Dec. 15, 2008, the disclosure of which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract Nos. NNJ07JB34C and NNC09CA05 awarded by the National Aeronautics and Space Administration (NASA) Johnson Space Center.

### BACKGROUND OF THE INVENTION

The present invention relates generally to batteries and more particularly to techniques for controlling short-circuiting in batteries, especially lithium-ion batteries.

Until recently, the principal thermal safety issues with lithium-ion rechargeable cells have been caused by external heating, resulting in gas formation and thermal runaway resulting from exothermic reactions involving the electrolyte and electrode materials. Cell venting from overheating due to internal or external short circuits has been less frequent, being limited by the rate capability of early commercial cells. At most, these litihium-ion cells could deliver power at 300 W/kg of cell mass sustained on a short circuit (see Owens, “Survey of Rechargeable Lithium Battery Technology,” Wrightsville Beach, N.C., prepared for The Electric Power Institute, 1996). With improvements in both cathode and anode materials and improvements in separators and more conductive electrolytes, reported specific power increased to 1135 W/kg by 1995 and increased to 4300 W/kg by 2006 (see A123 Systems, Inc., Technical Note: “Proper Assembly of A123 Systems High Power Lithium-Ion Cells into High Voltage and High Capacity Strings,” Watertown, Mass., May 12, 2006). This means that the effects of an uncontrolled short circuit occurring within the cell can be quite severe, with the potential for cell venting and fire (see Balakrisnan et al., “Review: Safety in Lithium Ion Batteries,” J. Power Sources, 155, 401, 2006).

A common means of controlling dangerous short circuit currents in battery-powered electrical equipment has been to include a fuse or fusible link in the external current-carrying circuit. At high currents and temperatures, the fusible link opens up to interrupt current flow (see U.S. Pat. No. 4,967,176, which is incorporated herein by reference). The fusible link can, in some cases, be designed into the interior of a cell, for example, by placing a fuse material between the electrode stack and the cell feedthrough such that all external shorting current must pass through the fuse, thus heating it up (see U.S. Pat. No. 7,175,935, which is incorporated herein by reference). These approaches, however, do not protect against venting a fire resulting from a high current short circuit occurring within the battery or cell case. If this happens, excessive internal heating can lead to irreversible cell damage and, possibly, cell case rupture and fire.

One approach to controlling internal short circuits in cells and batteries relies on a microporous separator material, through which ionic current must pass between the anode and cathode. During an internal short circuit, ionic current flow through the electrolyte can generate ohmic heating, which causes the polymer separator to swell causing the pore channels to close, thereby halting the short circuit-supporting ionic flow (see Laman et al., J. Electrochem. Soc., 140, L51, 1993 and Ozawa, Solid State Ionics, 69, 212, 1994). Unfortunately, in some thermal-runaway scenarios, the cell internal heating can cause the “shut-down” separator to melt, thereby opening up large gaps, causing uncontrolled internal short circuiting. In a effort to prevent total collapse of the electrode separator as it melts at elevated temperature, an approach was devised wherein a fusible microporous polyethylene separator sheet is laminated to a microporous polypropylene sheet. A similar approach involves bonding a microporous battery separator to an open webbing material imbibed with a waxy material which fuses at the desired temperature to block ionic flow through the membrane pores (see U.S. Pat. No. 4,741,979, which is incorporated herein by reference). According to another approach, inert polymer additives are placed in contact with the battery electrolyte for lithium-thionyl chloride cells, such that, at a given elevated temperature, the electrolyte solvent swells the polymer causing the ionic conductivity to drop and to reduce overheating (see U.S. Pat. No. 4,351,888, which is incorporated herein by reference).

According to yet another approach, an array of fusible dots are bonded to the surface of the microporous battery separator. At the desired safe temperature, the islands of fusible material melt and fill the open pores, blocking ionic current and reducing the short circuit flow. (see U.S. Pat. No. 6,475,666, which is incorporated herein by reference). Still another approach uses a nonwoven polymer separator (see U.S. Pat. No. 6,159,634, which is incorporated herein by reference). In yet another approach, a battery is provided with multiple layers of microporous sheets, one of which is chosen to fuse shut to prevent ionic current flow at temperatures of 80-150° C. (see U.S. Pat. Nos. 4,650,730 and 4,731,304, both of which are incorporated herein by reference). In still yet another approach, a rough mixture of course particles of non-conducting ETEFE (Tefzel®) and conducting nickel were combined into a 3-dimensional substrate consisting of expanded metal, which was then used as a cathode substrate in non-rechargeable (primary) lithium thionyl cells for short circuit control (see U.S. Pat. No. 4,603,165, which is incorporated herein by reference). The aforementioned approach suffers from the inability to make thin layers on electrode substrates. Consequently, the amount of material necessary for the switching effect undesirably adds to the electrode thickness and takes away from the specific energy and energy density of the cell.

All of the features currently available for enhancing safety during lithium-ion battery internal short circuits have drawbacks including: 1) susceptibility to dislodging from shock and vibration, 2) increase in cell internal resistance, 3) long-term compatibility issues with the organic electrolytes, and 4) deterioration of the safety feature at the high-temperature operating and storage conditions that commercial cells can occasionally encounter.

Additional documents of interest include the following, all of which are incorporated herein by reference: U.S. Pat. No. 4,967,176, inventors Horsma et al., which issued Oct. 30, 1990; U.S. Pat. No. 4,188,276, inventors Lyons et al., which issued Feb. 12, 1980; U.S. Patent Application Publication No. US2008/0193855 A1, inventor McDonald, published Aug. 14, 2008; and United Kingdom Patent Application Publication No. GB 1,529,354, which was published Oct. 18, 1978.

### SUMMARY OF THE INVENTION

It is an object of the present invention to provide a novel thermal switch material.

It is another object of the present invention to provide a thermal switch material as described above that is suitable for use in controlling internal and external short circuits in lithium-ion batteries.

It is still another object of the present invention to provide a thermal switch material as described above that addresses at least some of the disadvantages associated with conventional thermal switch materials.

In accordance with the teachings of the present invention, there is provided a composite thermal switch material which, when included as part of a battery or cell electronic current pathway, ceases to carry current at a pre-determined temperature, thus preventing overheating and case rupture. The composite thermal switch material can be processed to produce an open circuit at a temperature best suited for the chemistry and design of the particular battery or cell.

More specifically, the composite thermal switch material of the present invention comprises a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

The present invention is also directed at a method of fabricating the above-described composite thermal switch material.

The present invention is further directed at an electrode assembly including the above-described composite thermal switch material and to a lithium-ion cell or battery including said electrode assembly.

Additional objects, as well as aspects; features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a schematic perspective view of one embodiment of an apparatus for spray-coating a metal foil in accordance with the teachings of the present invention;

FIG. 2 is a schematic view of a lithium ion battery constructed in accordance with the teachings of the present invention;

FIG. 3 is a schematic section view of the cathode of the lithium ion battery of FIG. 2;

FIG. 4 is a graph, illustrating the resistance as a function of temperature of the composite thermal switch material of Example 8;

FIG. 5 is a graph, illustrating the resistance as a function of temperature of the composite thermal switch material of Example 9;

FIG. 6 is a graph, illustrating the resistance as a function of temperature of the composite thermal switch material of Example 10; and

FIG. 7 is a graph, illustrating the resistance of a function of temperature of the composite thermal switch material of Example 11.

### DETAILED DESCRIPTION OF PREFERRED EMBODIMENTS

The present invention is directed at a composite thermal switch material that comprises a substantially homogeneous matrix of metallic nanoparticles and non-electrically conductive polymeric nanoparticles, the non-electrically conductive polymeric nanoparticles being fused to one another and having a substantially greater thermal expansion coefficient than the metallic nanoparticles. The metallic nanoparticles and the non-electrically conductive polymeric nanoparticles are present in the substantially homogeneous matrix in relative proportions such that, at temperatures below a switching temperature, the metallic nanoparticles form electrically-conductive pathways through the switch material whereas, at temperatures at or above the switching temperature, the non-electrically conductive polymeric nanoparticles expand to an extent that the electrically-conductive pathways through the switching material are appreciably disrupted.

The metallic nanoparticles and the non-electrically conductive polymeric nanoparticles of the present invention may have a diameter of about 0.010 to 0.80 micron. Preferably, the aforementioned nanoparticles are less than 300 nanometers (0.3 micron) in diameter, more preferably about 0.020 micron to 0.20 micron in diameter, to ensure thorough mixing and co-mingling of the two types of materials.

The metallic nanoparticles of the present invention are not limited to any particular type of metal but may be, for illustrative purposes only, nickel nanoparticles or copper nanoparticles. The metallic nanoparticles are preferably spherical nanoparticles. Metallic nanoparticles comprising combinations of different types of metal may also be used.

The non-electrically conductive polymeric nanoparticles of the present invention are not limited to any particular type of polymer but may include, for illustrative purposes only, polytetrafluoroethylene (PTFE). Non-electrically conductive polymeric nanoparticles comprising combinations of different types of polymeric materials may also be used.

Where, for example, the metallic nanoparticles are nickel nanoparticles, the non-electrically conductive polymeric nanoparticles are PTFE nanoparticles, and both types of nanoparticles have a diameter of about 20 to 200 nanometers, the switch material may be about 8-15% by volume nickel, with the balance being PTFE.

In addition to the metallic nanoparticles and non-electrically conductive polymeric nanoparticles discussed above, other types of electrically-conductive particles and insulating particles which have substantially different thermal expansion coefficients may also be used, as required, to address issues of chemical compatibility with battery internal materials.

When the ratios of particle sizes and volume fractions are properly chosen, the composite thermal switch material of the present invention is electronically conductive at the operating temperatures of a particular chemistry and design of a lithium-ion battery. When subjected to excessive heat, the composite polymer particles in the matrix will expand more than the conductive metal particles to break conductive pathways, producing an insulating layer. The short circuit current is thereby interrupted within the cell or battery, limiting or eliminating the overheating.

A film consisting of the composite thermal switch material of the present invention may have a thickness of about 25-250 microns. Such a film may be fabricated by combining appropriate quantities of the various types of nanoparticles, which are preferably in powder form, and then mixing the various nanoparticles together until they are substantially uniformly blended. Then, an appropriate quantity of the mixture may be loaded into a cavity in a mold, and heat and pressure may be applied to the mixture in the mold until the polymeric nanoparticles fuse to one another and a thin film is formed. Alternatively, such a film may be prepared by spreading the blended mixture on top of a metal foil, covering the mixture with a second piece of foil, and then rolling (i.e., calendaring) the ensemble through a set of jeweler's wheels to create a continuous piece of uniform composite material, which material may then be separated from the foils to produce a thin, self-supporting film.

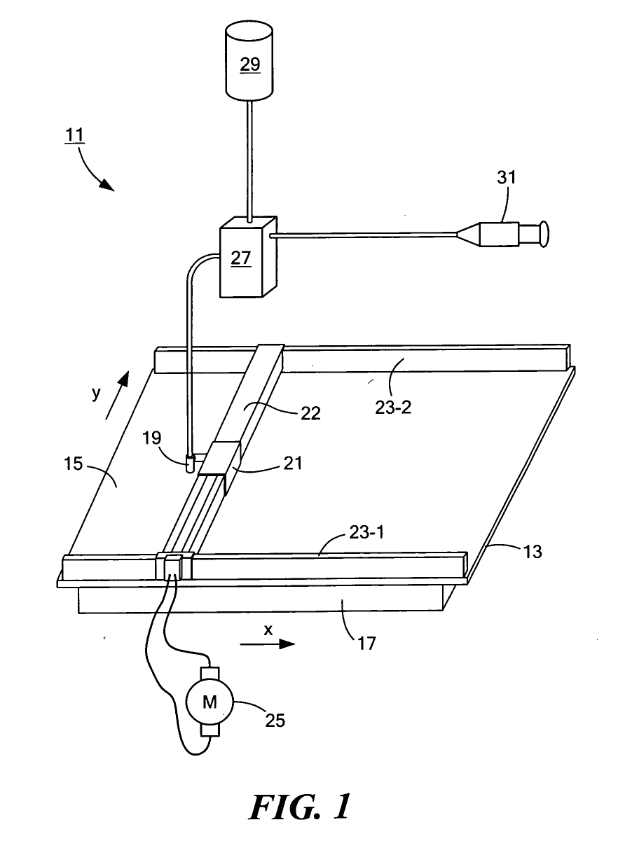

Yet another process for producing such a film may comprise preparing a dispersion comprising a suitable carrier solvent, such as tertiary butanol or a similar organic solvent, and the above-described mixture of metallic nanoparticles and non-electrically conductive polymeric nanoparticles. Next, the dispersion may be printed or sprayed onto a metal foil positioned on a heat-conductive plate using a dispenser positioned above the metal foil and the heat-conductive plate. (If desired, the top surface of the metal foil may be pre-treated with a thin coating of a conductive carbon primer, such as Adcote® (Rohm and Haas) conductive carbon primer, to provide good conductive interface with the metal substrate and to provide adhesion to the substrate.) Preferably, the dispenser is moved incrementally in a controlled fashion in both x and y directions relative to the metal foil and heat-conductive plate so that the top surface of the metal foil may be covered in its entirety in a controlled fashion. The heat-conductive surface is preferably simultaneously heated from below by a heater positioned directly under the heat-conductive surface. In this manner, the solvent is caused to vaporize from the metal foil within a matter of seconds after being applied. The dispenser may sweep over the metal foil multiple times (preferably starting at different corners of the metal foil each time) in order to build the film coating on the foil up to a desired thickness. An example of an apparatus constructed in accordance with the teachings of the present invention and adapted for spray-coating a metal foil with the above-described dispersion of mixed metallic and polymeric nanoparticles is shown schematically in FIG. 1 and is represented generally by reference numeral 11.

Apparatus 11 comprises a generally planar rectangular platform 13. Platform 13, which has a top surface 15 for receiving a metal foil to be coated, is preferably made of a durable, heat-conductive material, such as a suitable metal. Apparatus 11 also comprises a heater 17, heater 17 being operatively positioned under platform 13 to cause the top surface 15 of platform to become heated. Apparatus 11 additionally comprises a fluid dispenser 19 for dispensing the nanoparticle dispersion in an aerosol spray onto the top surface of a metal foil positioned on platform 13. Accordingly, dispenser 19 is suitably spaced over platform 13. Apparatus 11 further comprises a mechanism for moving dispenser 19 in the x and y directions relative to platform 13 so that dispenser 19 may be incrementally positioned over the entire top surface of the metal foil positioned on platform 13. Said moving mechanism may comprise a bracket 21 on which dispenser 19 is fixedly mounted, a bar 22 on which bracket 21 is slidably mounted in the y direction, a pair of rails 23-1 and 23-2 on which bracket 21 is slidably mounted in the x direction, and a motor 25 for selectively sliding bracket 21 and/or bar 22. Apparatus 11 further comprises a fluid reservoir 27 for supplying dispenser 19 with the dispersion, as well as a continuously mixing gravity feeder 29 and a syringe 31, either of which may be used to replenish fluid reservoir 27.

After the spraying of the film coating on the foil is complete, the coated foil is removed from the heat-conductive plate and is compressed between a pair of heated platens under suitable conditions of temperature and pressure to cause the polymeric nanoparticles to fuse to one another.

The switch material of the present invention may take the form of a film or circuit link that carries current delivered by an electrochemical cell or battery and is located within the cell or battery case and that loses conductivity. In its simplest form, the switch material may be placed as a thin film on the surface of the anode and or the cathode current collector, between the electrode active material and the substrate.

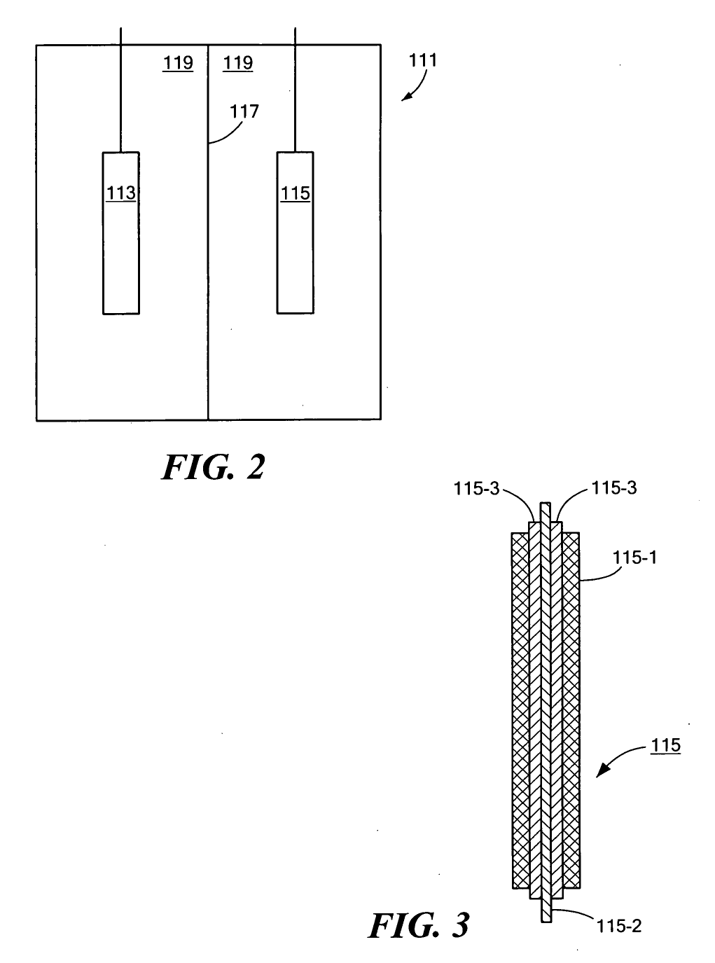

Referring now to FIG. 2, there is shown a schematic view of a lithium ion battery constructed in accordance with the teachings of the present invention, said lithium ion battery being represented generally by reference numeral 111.

Battery 111 includes an anode 113, a cathode 115, a separator 117, and an electrolyte 119. Anode 113 may be a conventional carbon anode or may further include the composite thermal switch material of the present invention positioned between the electrode active material and the substrate. Cathode 115 may be a conventional lithium cobalt oxide cathode or may further include the composite thermal switch material of the present invention positioned between the electrode active material and the substrate. Separator 117 may be conventional, and electrolyte 119 may be conventional.

Referring now to FIG. 3, cathode 115 of FIG. 2 is shown in greater detail. As can be seen, cathode 115 comprises a reduction layer 115-1, a conductive substrate 115-2, and a composite thermal switch layer 115-3, thermal switch layer 115-3 being disposed between reduction layer 115-1 and conductive substrate 115-2 and having a composition as described above. The surface of reduction layer 115-1 is where the cathode material is electrochemically reduced. Reduction layer 115-1 may comprise, for example, carbon particles and a binder. Conductive substrate 115-2 may be made of a metal, such as stainless steel or nickel, and does not take part in the electrochemical reaction. The purpose of conductive substrate 115-2 is to provide mechanical support for layers 115-1 and 115-3, as well as to provide a low resistance path for current generated by the electrochemical reaction.

It should be understood that an anode incorporating the composite thermal switch material of the present invention may have a construction analogous to that described above for cathode 115.

The examples below are illustrative only and do not limit the present invention.

### EXAMPLE 1

### Mixing Method With 50-nm Nickel Nanoparticles

200-nm tetrafluoroethylene (TFE) powder (Polysciences, Inc., Warrington, Pa.) was blended with different quantities of 50-nanometer nickel particles (Reade Metals, Riverside, R.I.) over a 24-hour period to produce mixtures having 8%, 9% and 10%, respectively, nickel by volume. The material was handled in a drybox to avoid electrostatic charging of the polymer particles. A nickel wire whisk was placed with the powders in a glass jar and rotated for the aforementioned period of time. The result was a uniform-appearing homogeneous co-mixture of the two nanomaterials.

### EXAMPLE 2

### Mixing Method With 200-nm Nickel Nanoparticles

200-nm tetrafluoroethylene (TFE) powder (Polysciences, Inc.) was blended with 200-nanometer APS (spherical) nickel particles over a 3-day period to produce mixtures having 8%, 9% and 10%, respectively, nickel by volume. The material was handled in a drybox to avoid electrostatic charging of the polymer particles. A nickel wire whisk was placed with the powders in a glass jar and rotated for the aforementioned period of time. The result was a uniform-appearing homogeneous co-mixture of the two nanomaterials.

### EXAMPLE 3

### Preparation of Nanoparticle Composite Film Coupons By Hot Molding

125-250 micron-thick film coupon samples were prepared using eight-volume-percent nickel to ten-volume-percent nickel mixtures of either 50-nm or 100-nm APS nickel with TFE. A 2.25″ diameter cavity mold was used to compress the nickel/TFE powder mixtures at 274° F. and 5000 psi. The result was a continuous homogeneous coupon in which the two types of particles were not separated.

### EXAMPLE 4

### Preparation of Nanoparticle Composite Film Coupons By Spraying

In a second coupon preparation method, the nickel/TFE powder was suspended in liquid butanol. The powder/butanol suspension was sonicated for 30 seconds using a Branson Model 250 at 200 Watts. The resulting suspension was then sprayed onto a 50 micron-thick Kapton® film using a chromatography sprayer (General Glassblowing, Richmond, Calif.) artist's aerosol application and compressed nitrogen. The Kapton® substrate was taped onto an aluminum plate which was maintained at 78° C. Following spraying, the samples were put into a 100° C. oven for seven minutes to evaporate residual solvent. The result was a homogeneous composite film of nickel and TFE nanoparticles on Kapton® which could then be handled for subsequent process steps. Sintering the films for 30 minutes at 200° C. and then pressing for one minute at 7000 psi produced a homogeneous, continuous coupon. The thickness of this coupon was approximately 150 microns.

### EXAMPLE 5

### Preparation of Nanoparticle Composite Film Coupon By Calendaring

A third method of preparing a coupon used the jar-mill mixed nickel-Teflon powder mix described above. The mixture was spread out on top of a 75 micron tantalum metal foil, and covered with a second piece of foil. The ensemble was then rolled (i.e. calendared) through a set of jeweler's wheels (Grobet USA), which created a continuous piece of uniform composite material. The composite was easily separated from the foils to produce a thin, self-supporting film.

### EXAMPLE 6

### Preparation of Composite Film-On-Metal Coupons

Bonded 150-micron thick films were prepared on 75-micron thick titanium and tantalum foils using the same sequence of spraying, warming, and pressing conditions as given above in Example 4. The coated metal foils were then additionally sintered at 350° C. for 30 minutes. This step resulted in well-bonded composite material on both metal foils.

### EXAMPLE 7

### Preparation of Composite Film Coupons By Calendaring

Another method of preparing the film coupons involved a jelly-roller and the above-described jar-mill mixed nickel/TFE powder mix. The mixture was spread out on top of a piece of metal foil and was covered with a second piece of foil. Then, the ensemble was rolled through a jelly-roller, which created a continuous piece of composite material, which did not stick to the foil.

### EXAMPLE 8

### Thermal Switch Behavior of Composite Thermal Switch Film On Metal Foil

0.050-micron APS nickel powder was combined with 0.20-micron PTFE powder as described in Example 1 to produce a uniform mix with 8% nickel by volume and 92% PTFE by volume. This mixture was aerosol-sprayed onto tantalum foil as described in Example 5. The coated foil was compressed at 177° C. for 20 minutes under 5000 psi. This resulted in a homogeneous, uniform, adherent coating. The coated foil coupon was then held between two copper plates with a spring clip. The assembly was heated over 60 minutes in an oven while measuring resistance through the film between the copper plates. As can be seen in FIG. 1, at 174° C., the material switched to an insulator over approximately a 3° C. temperature range.

### EXAMPLE 9

### Behavior of Composite Thermal Switch Film On Metal Foil

0.100-micron APS nickel powder was combined with 0.200-micron PTFE powder as described in Example 1 to produce a uniform mix with 8% nickel by volume and 92% PTFE by volume. This mixture was aerosol-sprayed onto tantalum foil as described in Example 5. The coated foil was compressed at 300° C. for 30 minutes under 7000 psi. This resulted in a homogeneous, uniform, adherent coating on the foil. The coated foil coupon was then held between two copper plates with a spring clip. The assembly was heated to 200° C. over 5 minutes in an oven while measuring resistance through the film between the copper plates. As can be seen in FIG. 2, the material exhibited a 100× increase in resistance over the temperature range of 107° C. to 119° C.

### EXAMPLE 10

### Behavior of Composite Thermal Switch Film On Metal Foil

0.100-micron spherical copper powder was combined with 0.200-micron PTFE powder as described in Example 1 to produce a uniform mix with 15% copper by volume and 85% PTFE by volume. This mixture was aerosol-sprayed onto a 75 micron thick copper foil as described in Example 5. The coated foil was compressed at 300° C. for 30 minutes under 7000 psi. This resulted in a homogeneous, uniform, adherent coating on the copper foil. The coated foil coupon was then held between two copper plates with a spring clip. The assembly was heated over one minute in an oven while measuring resistance through the film between the copper plates. As can be seen in FIG. 3, the resistance of the material increased 70% over the temperature range of 40° C. to 43° C.

### EXAMPLE 11

### Coating On Copper Foil

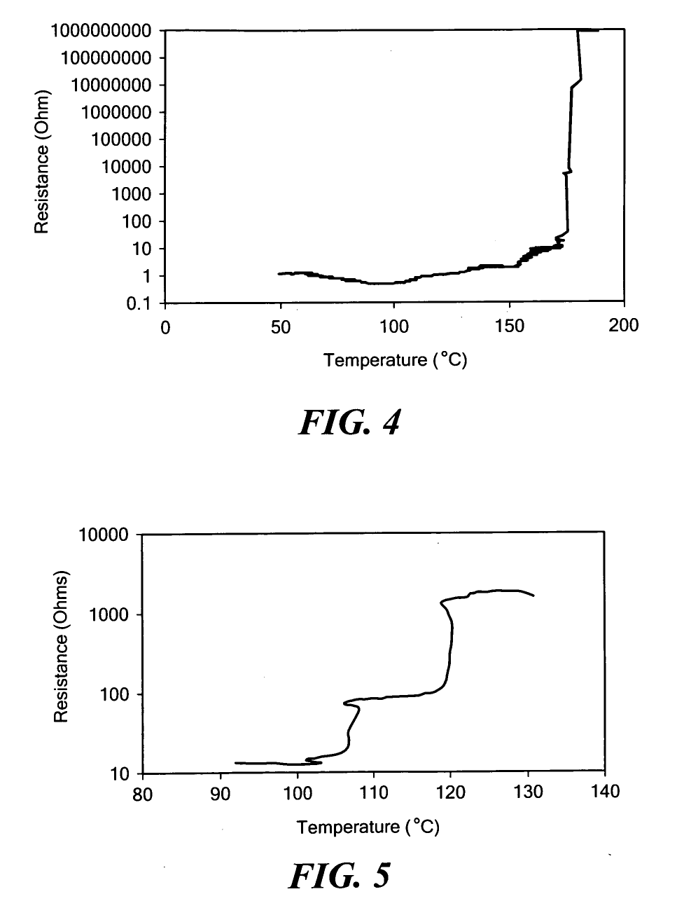

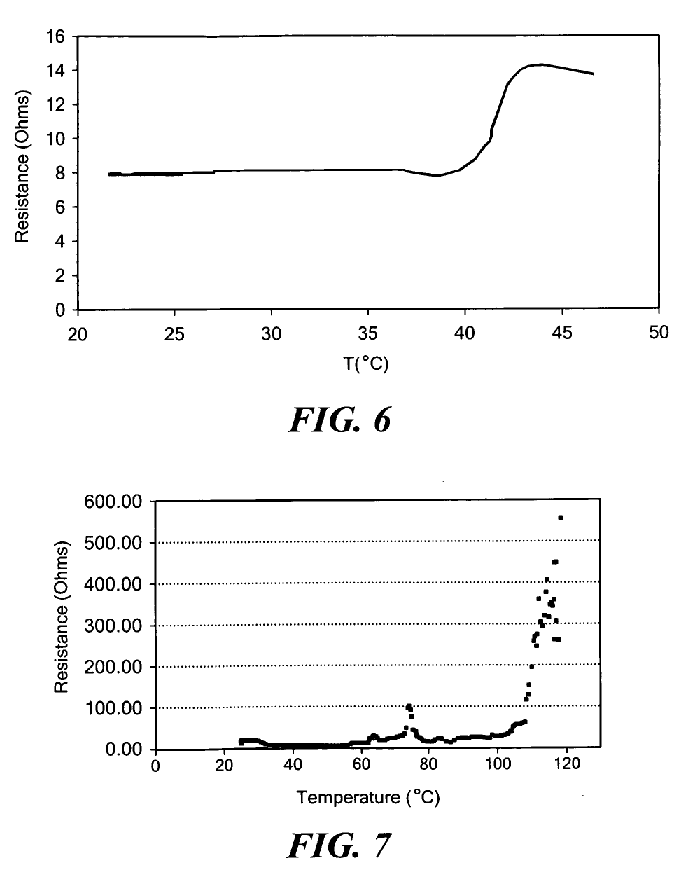

A process was developed with the objective to produce a thinner film and to reduce the pressure and temperature required to manufacture the film. 0.100 micron spherical nickel powder was combined with 0.200 micron PTFE powder as described in Example 1 to produce a uniform mix with 8.4% nickel by volume and 91.6% PTFE by volume. A 2 mil (25 micron) copper foil was first coated with a thin coating of Adcote™ (Rohm and Haas) conductive carbon primer. The purpose of the primer was to provide good conductive interface with the metal substrate and to provide adhesion to the substrate. A dispersion of the powder mixture in tertiary butanol was prepared and was continuously mixed while gravity-feeding to an aerosol-sprayer. The dispersion was then aerosol-sprayed onto copper foil. The liquid was evaporated continuously during application with the aid of a heater set to 90° C., the heater being positioned under a platform supporting the copper foil. A 1 mil (25 micron) thick coating was thus prepared on the foil. The foil was then compressed between a pair of heated platens, the heated platens being set at a pressure of 28 psi and being heated to 143° C. for 40 minutes. During this time, the pressure rose to 100-125 psi as the platens expanded. This resulted in a homogeneous, uniform, adherent composite coating on the copper foil. The coated foil was then held between two gold-plate stainless steel plates to measure through-plane resistance. The assembly was heated at 1° C./minute in a computer-controlled oven, while monitoring resistance and temperature. As can be seen in FIG. 4, the material resistance increased 4-fold at 74° C. followed by a 100-fold increase over the temperature range of 107° C. to 117° C.

As noted above, the foregoing examples are merely illustrative. The invention also may be useful in other electrochemical devices including aqueous batteries and capacitors to reduce heat-producing short circuits. The invention may be embodied as a thin film coating on battery electrode substrates to control high current flow and overheating. Other forms of the material might also prove useful, such as a circuit breaker connecting electrode tabs to a bus bar, or connecting a battery bus bar to the battery case terminal feedthrough. The small, nanoscale dimension of the constituent conducting and insulating particles which make up the present composite means that the composite material may be thermally formed into a variety of useful shapes including bars, foils and wires.

Combinations of nanoscale polymer powders combined with nanoscale metal particles in more corrosive and aggressive electrolytes (e.g., sulfur dioxide containing) may also be used. If this is done, the metal:polymer particle size ratio needs to be optimized for the particular temperatures at which the battery must operate and must cease to operated in the event of a short circuit.

The embodiments of the present invention described above are intended to be merely exemplary and those skilled in the art shall be able to make numerous variations and modifications to it without departing from the spirit of the present invention. For example, it will be understood that a range of switch temperatures for the material can be obtained by optimization of the composition and processing conditions. It is also evident that a person of ordinary skill in the art of battery science and manufacturing may be able to apply the claimed composite thermal switch film for internal protection in other types of batteries, provided a suitable, chemically-compatible combination of conductor and non-conductor nanoparticles is used. All such variations and modifications are intended to be within the scope of the present invention as defined in the appended claims.

What is claimed is:

1. A composite thermal switch material suitable for use in controlling short-circuiting in a lithium-ion battery, said composite thermal switch material comprising a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

2. A composite thermal switch material as claimed in claim 1, wherein the metallic nanoparticles and the non-electrically conductive polymeric nanoparticles have a diameter of about 0.010 to 0.80 micron.

3. A composite thermal switch material as claimed in claim 2, wherein the metallic nanoparticles and the non-electrically conductive polymeric nanoparticles have a diameter less than 0.30 micron.

4. A composite thermal switch material as claimed in claim 3, wherein the metallic nanoparticles and the non-electrically conductive polymeric nanoparticles have a diameter of about 0.020 to 0.20 micron.

5. A composite thermal switch material as claimed in claim 1, wherein the metallic nanoparticles are selected from the group consisting of nickel nanoparticles and copper nanoparticles.

6. A composite thermal switch material as claimed in claim 4, wherein the metallic nanoparticles are nickel nanoparticles.

7. A composite thermal switch material as claimed in claim 5, wherein the non-electrically conductive polymeric nanoparticles are polytetrafluoroethylene (PTFE) nanoparticles.

8. A composite thermal switch material as claimed in claim 1, wherein the metallic nanoparticles constitute about 8-15% by volume of the composite thermal switch material.

9. A composite thermal switch material as claimed in claim 1, wherein said composite thermal switch material has a thickness of about 25 to 250 microns.

10. A laminate structure comprising:
(a) a metal foil; and
(b) a composite thermal switch material deposited on said metal foil, said composite thermal switch material comprising a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

11. The laminate structure as claimed in claim 10, wherein the composite thermal switch material is deposited directly on said metal foil.

12. The laminate structure as claimed in claim 10, further comprising a conductive carbon primer layer interposed between said metal foil and said composite thermal switch material.

13. An electrode assembly, said electrode assembly comprising:
(a) an electrode active material;
(b) an electrically conductive substrate; and
(c) a composite thermal switch material positioned between said electrode active material and said electrically conductive substrate, said composite thermal switch material comprising a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

14. The electrode assembly as claimed in claim 13 wherein the electrode is a cathode.

15. The electrode assembly as claimed in claim 13 wherein the electrode is an anode.

16. A lithium-ion battery, said lithium-ion battery comprising:
(a) an electrolyte suitable for conducting lithium ions;
(b) an anode in contact with the electrolyte, the anode containing lithium; and
(c) a cathode in contact with the electrolyte, the cathode being electrically connected to the anode;
(d) wherein at least one of the anode and the cathode comprises (i) an electrode active material; (ii) an electrically conductive substrate; and (iii) a composite thermal switch material, said composite thermal switch material being positioned between said electrode active material and said electrically conductive substrate, said composite thermal switch material comprising a substantially homogeneous matrix of metallic nanoparticles and non-electrically conductive polymeric nanoparticles, the non-electrically conductive polymeric nanoparticles being fused to one another and having a greater thermal expansion coefficient than the metallic nanoparticles, the metallic nanoparticles and the non-electrically conductive polymeric nanoparticles being present in said substantially homogeneous matrix in relative proportions such that the composite thermal switch material is electrically conductive below a switching temperature and is substantially non-electrically conductive at or above the switching temperature.

17. A lithium-ion battery as claimed in claim 16, wherein said anode comprises said electrode active material; said electrically conductive substrate; and said composite thermal switch material.

18. A lithium-ion battery as claimed in claim 16, wherein said cathode comprises said electrode active material; said electrically conductive substrate; and said composite thermal switch material.

19. A lithium-ion battery as claimed in claim 16, wherein each of said anode and said cathode comprises said electrode active material; said electrically conductive substrate; and said composite thermal switch material.

20. A method of preparing a composite thermal switch material, said method comprising the steps of:
(a) providing a mixture of metallic nanoparticles and non-electrically conductive polymeric nanoparticles, the non-electrically conductive polymeric nanoparticles having a greater thermal expansion coefficient than the metallic nanoparticles;
(b) preparing a dispersion comprising said mixture in an organic carrier solvent;
(c) spraying said dispersion onto a metal foil until a thin coating is formed thereon;
(d) heating the coated metal foil to vaporize the organic carrier solvent; and
(e) compressing the coated metal foil at an elevated temperature to cause the polymeric nanoparticles in the thin coating to fuse to one another, wherein the metallic nanoparticles and the non-electrically conductive polymeric nanoparticles are present in the thin coating in relative proportions such that the thin coating is electrically conductive below a switching temperature and is substantially non-electrically conductive at or above the switching temperature.

21. The method as claimed in claim 20 wherein steps (c) and (d) are conducted simultaneously.

22. The method as claimed in claim 20 wherein said compressing step takes place at a pressure of 20-200 psi and at a temperature of 140-150° C.
